(19) United States
(12) Patent Application Publication
(10) Pub. No.: US 2008/0239158 A1
(43) Pub. Date: Oct. 2, 2008

(54) ADAPTIVE GAMMA VOLTAGE SWITCHING METHOD AND DEVICE USING THE SAME

(75) Inventors: Chih-Lei Wu, Taipei City (TW); Kuan-Hung Liu, Taipei Hsien (TW); Yi- Nan Chu, Changhua Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/767,528

(22) Filed: Jun. 25, 2007

(30) Foreign Application Priority Data
Mar. 28, 2007 (TW) 96110707

(51) Int. Cl. H04N 5/202

(52) U.S. Cl. 348/677; 348/E05.074

(57) ABSTRACT

An adaptive Gamma voltage switching method and a device using the same is presented. An equalization unit utilizes a video data to obtain an equalized luminance data. An adaptive Gamma voltage switching core dynamically adjusts a Gamma voltage and outputs the adjusted Gamma voltage to a panel according to the equalized luminance data so as to enable the panel to alternately display a black insertion frame and a dynamic frame with adaptive contrast. The present invention not only enhances frame contrast but also reduces frame blur, and furthermore improves the insufficient luminance caused by black insertion.

### CROSS-REFERENCE TO RELATED APPLICATION

This application claims the priority benefit of Taiwan application serial no. 96110707, filed Mar. 28, 2007. All disclosure of the Taiwan application is incorporated herein by reference.

### BACKGROUND OF THE INVENTION

1. Field of the Invention

The present invention generally relates to a switching method and a device using the same, and more particularly, to an adaptive Gamma voltage switching method and a device using the same.

2. Description of Related Art

Along with the booming progress of liquid crystal display (LCD) technology, consumers have higher requirements on an LCD relating not only to lightness and smallness of the display, but also colorful, clear and bright frame display quality. To meet the requirements of modern people, the manufactures have developed various techniques to improve the frame display quality.

Taking a thin-film transistor liquid crystal display (TFT-LCD) as an example, the major targets to improve dynamic frame quality today rests in color processing, contrast enhancement and blur drop.

FIG. 1 is a circuit block diagram illustrating a conventional gradation reference voltage device. Referring to FIG. 1, a conventional gradation reference voltage device mainly includes a control board 11 and source driver integrated circuits 12, wherein the control board 11 includes a timing controller 113 and a resistor-string and buffer unit 115 for receiving a video data and outputting the video data together with an appropriate control signal to drive the source driver integrated circuits 12.

FIG. 2 is a circuit diagram of a conventional resistor-string and buffer unit and FIG. 3 is an unchanged Gamma curve graph used by the prior art. Referring to FIGS. 2 and 3, the gradation reference voltage of a conventional TFT-LCD usually is formed by multiple resistor-string dividing voltages, while each gradation reference voltage is fixed once the resistor-string is defined. The unchangeable dividing voltage resistances make a Gamma characteristic curve unchangeable as well. The prior art only provides a set of gradation voltage values of a Gamma characteristic curve to the source driver integrated circuit 12 and then to a panel 21. Therefore, all frames are adjusted based on the unchanged Gamma characteristic curve shown in FIG. 3 only. Moreover, circuit architecture of the prior art has no mechanism to judge frames. Therefore, it is impossible to appropriately adjust the Gamma curve according to the display behaviour of dynamic frames. In short, the major disadvantage of the conventional circuit architecture is that dynamic frames are unable to properly present color brightness, which would largely degrade display quality.

In terms of frame processing, one of significant projects is to reduce frame blur. The common blur-reducing techniques are currently including overdrive scheme, black insertion (BI) scheme, optically self-compensated birefringence (OCB) scheme and so on. In order to implement overdrive scheme, it requires that the frames are based on an unchangeable Gamma characteristic curve. Thus, dynamic frames needing a changeable Gamma characteristic curve are unsuitable to use the overdrive scheme. That is to say, it is quite difficult for dynamic frames to be more vivid with less blur by using a Gamma characteristic curve.

Frame black insertion is mainly categorized into data black insertion mode and backlight black insertion mode. The data black insertion mode requires a normal frame data and a black frame data of a TFT-LCD are alternately displayed on two successive frames or together displayed in sharing manner on a frame. The backlight black insertion mode of a TFT-LCD includes blinking backlight scheme where backlight is turned on and off, and scanning backlight scheme where backlight is sequentially turned on and off. The disadvantage of backlight black insertion mode is: it requires an additional hardware for controlling backlight, increases cost and shortens the lifetime of the backlight module; the starting time point of the backlight must be precisely controlled to suit the liquid crystal response characteristic; and it is difficult to be adjusted. Moreover, both the data black insertion mode and the backlight black insertion mode would weaken the display luminance, so that how to compensate an insufficient luminance becomes another concern of the manufacturers.

The US patent application No. 20060017682 provides an optically compensated birefringence (OCB) mode display driving device, which employs a power supply control circuit to provide an independent frame black-frame insertion reference voltage and an image reference voltage to the source driver thereof; to solve the problems of reduced frame luminance and decreased contrast caused by increasing a frame black insertion rate. However, the provided scheme requires providing an independent voltage to achieve a frame black insertion, which increases not only the circuitry complexity, but also increases the cost.

Accordingly, the panel manufacturers have made a lot of efforts to overcome the above-mentioned problem.

### SUMMARY OF THE INVENTION

The present invention is directed to an adaptive Gamma voltage switching method for enhancing contrast and reducing frame blur to promote the display effect.

The present invention is directed to an adaptive Gamma voltage switching device for enhancing contrast and reducing frame blur to promote the display effect.

As embodied and broadly described herein, the present invention provides an adaptive Gamma voltage switching method, which includes: conducting a statistic processing on a video data to obtain an equalized luminance data of the video data by statistics; dynamically adjusting a Gamma voltage according to the equalized luminance data; and converting the video data by using the adjusted Gamma voltage.

As embodied and broadly described herein, the present invention provides also an adaptive Gamma voltage switching device, which includes an equalization unit and a Gamma switching unit. The equalization unit conducts a statistic processing on the video data to obtain a cumulative distribution function (CDF) of luminance, i.e., an equalized luminance data. An adaptive Gamma voltage switching core (AGVS core) dynamically adjusts the Gamma voltage according to the equalized luminance data and provides the Gamma voltage to a digital-to-analog converter unit (DAC unit), wherein the DAC unit corrects the video data by using the Gamma voltage, so that the panel alternately presents a black insertion frame and a dynamic frame with adaptive contrast.

The present invention adopts architecture to dynamically adjust the Gamma voltage, therefore, the present invention is able to adjust the intensity of contrast data, enhance brightness perception and improve dynamic frame quality, which are advantageous in not only enhancing dynamic contrast and reducing blur by frame black insertion, but also compensating insufficient luminance caused by frame black insertion.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram illustrating a conventional gradation reference voltage device.

FIG. 2 is a circuit diagram of a conventional resistor-string and buffer unit.

FIG. 3 is an unchanged Gamma curve graph used by the prior art.

FIG. 4 is a circuit block diagram of an LCD driving circuit with an adaptive Gamma voltage switching device according to an embodiment of the present invention.

FIG. 5A is a circuit block diagram of an adaptive Gamma voltage switching core 427 according to an embodiment of the present invention.

FIG. 5B is a block diagram expressing the relationship between the adaptive Gamma voltage switching core 427 of an embodiment of the present invention and peripheral circuits.

FIG. 6 shows control signal waveforms of an adaptive Gamma voltage switching device 42 according to an embodiment of the present invention.

FIG. 7 is a graph showing curves of gradation over output luminance according to an embodiment of the present invention.

FIG. 8 is a circuit block diagram of an LCD driving circuit with an adaptive Gamma voltage switching device according to another embodiment of the present invention.

FIG. 9A is a circuit block diagram of an adaptive Gamma voltage switching core 827 according to another embodiment of the present invention.

FIG. 9B is a block diagram expressing the relationship between the adaptive Gamma voltage switching core 827 of another embodiment of the present invention and peripheral circuits.

FIG. 10 is a graph showing another curves of gradation over output luminance according to the embodiments of the present invention.

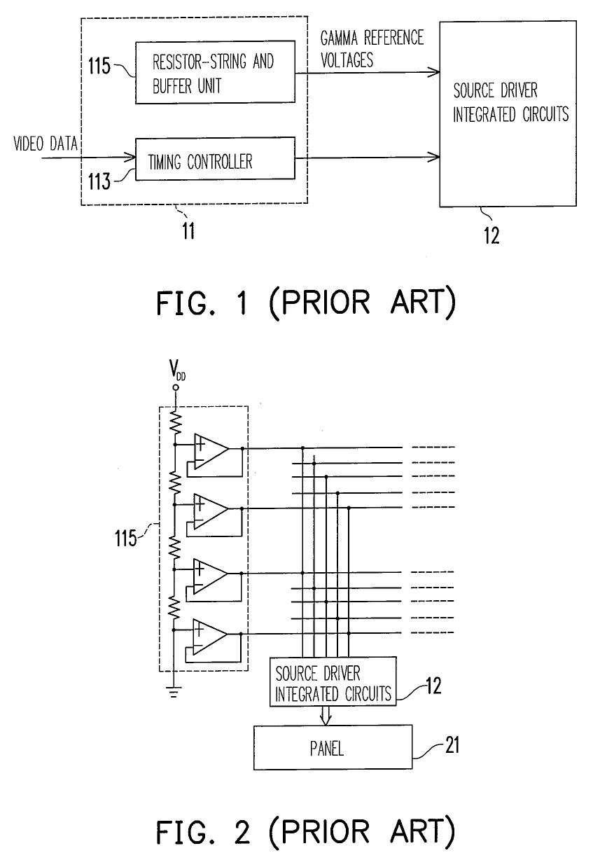

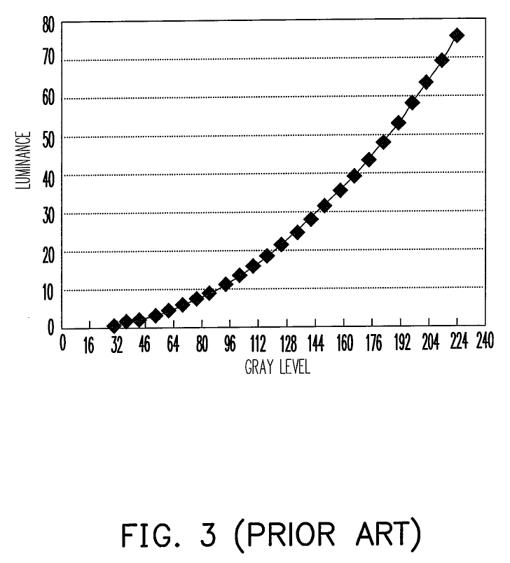

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

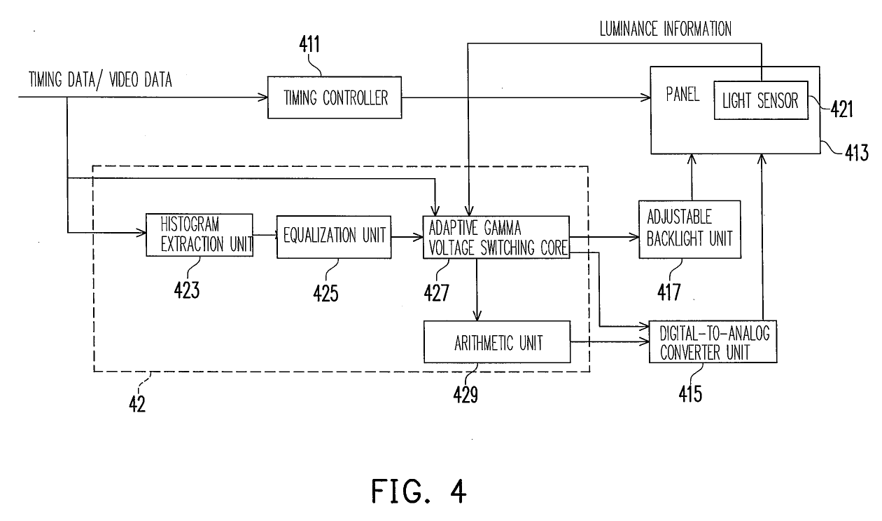

FIG. 4 is a circuit block diagram of an LCD driving circuit with an adaptive Gamma voltage switching device according to an embodiment of the present invention. Referring to FIG. 4, the LCD driving circuit includes a timing controller 411, a panel 413, a digital-to-analog converter unit 415 (DAC unit), an adjustable backlight unit 417, an adaptive Gamma voltage switching device 42 and a light sensor 421. The timing controller 411 is coupled to the panel 413 to provide the panel 413 with a control signal and a data required by display and the panel 413 is for displaying the data. The DAC unit 415 is employed for adjusting different Gamma characteristic curve corresponding to different display frames, so that a digital signal data is converted into a voltage to drive pixels and a digital gradation voltage data provided by the adaptive Gamma voltage switching device 42 is converted into an analog gradation voltage data to be output to the source driving circuit of the panel 413.

The light sensor 421 on the panel 413 is coupled to the adaptive Gamma voltage switching device 42 for detecting the luminance of the display frame of the panel 413 to reveal a problem of insufficient gray level or insufficient brightness, and the luminance information is output to the adaptive Gamma voltage switching device 42. The adjustable backlight unit 417 is coupled between the panel 413 and the adaptive Gamma voltage switching device 42 for receiving a luminance control signal processed by the adaptive Gamma voltage switching device 42 for adjusting the backlight luminance to compensate the insufficient luminance or insufficient brightness caused by frame black insertion.

It should be noted that the adaptive Gamma voltage switching device 42 further includes a histogram extraction unit 423, an equalization unit 425, an adaptive Gamma voltage switching core (AGVS core) 427 and an arithmetic unit 429. The histogram extraction unit 423 is adopted for generating a histogram based on the input video data and obtains a probability distribution function (PDF) data by a statistic processing. The equalization unit 425 is coupled to the histogram extraction unit 423 derives a cumulative distribution function (CDF) from the PDF statistic data, followed by obtaining a data of mapping an input gradation to an output gradation after a contrast modulation processing according to the CDF data and outputting the data of mapping an input gradation to an output gradation to the AGVS core 427. In other words, the AGVS core 427 dynamically adjusts the Gamma voltage according to the equalized luminance data and provides the Gamma voltage to the DAC unit 415. The DAC unit 415 hereby enables the panel 413 to alternately present a black insertion frame and a dynamic frame with adaptive contrast. A dynamic frame is analyzed in the above-mentioned way, so that an appropriate contrast enhancement suitable for different frames and the variation thereof is possible.

In addition to synchronously receiving a timing data for Vertical Sync signal (vertical synchronization signal) and a timing data for Dena signal (data enabling signal) and receiving the luminance information detected by the light sensor 421 on the panel 413, the AGVS core 427 in the above-mentioned adaptive Gamma voltage switching device 42 further receives the data of mapping an input gradation to an output gradation after the contrast modulation processing. After the AGVS core 427 conducts a processing on the above-mentioned data, the AGVS core 427 generates a luminance control signal, a voltage mapping data for alternately displaying a dynamic frame with adaptive contrast and a black insertion frame, and a DAC control signal, wherein the luminance control signal is for controlling the adjustable backlight unit 417 to compensate the insufficient luminance or insufficient brightness caused by frame black insertion.

The DAC control signal is to enable or disable the DAC unit 415 for the DAC unit 415 to convert a digital gradation voltage data into an analog gradation voltage data. The arithmetic unit 429 is coupled between the AGVS core 427 and the DAC unit 415 conducts an operation on the voltage mapping data for alternately displaying a black insertion frame and a dynamic frame with adaptive contrast generated by the AGVS core 427 and then generates a digital gradation reference voltage to be in sequence output to the DAC unit 415. The more details of the internal architecture of the AGVS core 427 is described hereinafter.

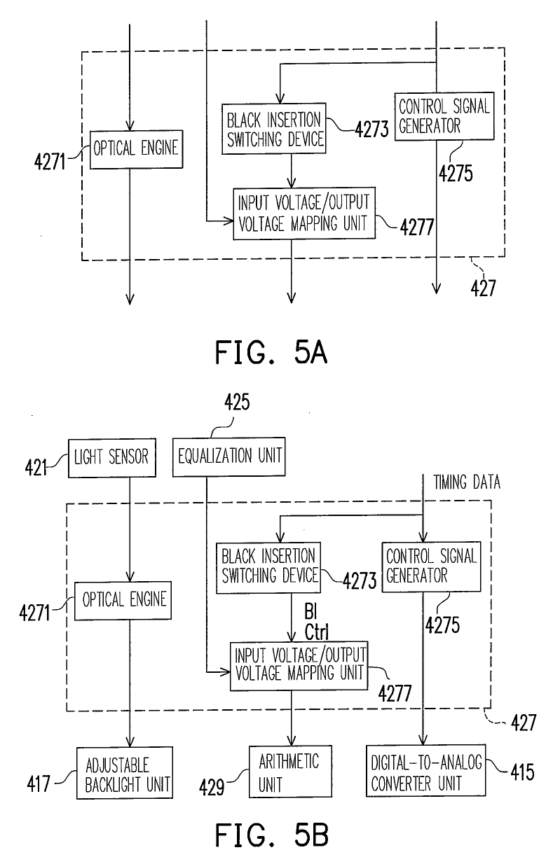

FIG. 5A is a circuit block diagram of an adaptive Gamma voltage switching core 427 according to an embodiment of the present invention and FIG. 5B is a block diagram expressing the relationship between the adaptive Gamma voltage switching core 427 of an embodiment of the present invention and peripheral circuits. Referring to FIGS. 5A and 5B, the AGVS core 427 includes an optical engine 4271, a black insertion switching device (BI switching device) 4273, a control signal generator 4275 and a input voltage/output voltage mapping unit 4277. The optical engine 4271 herein receives the luminance data from the light sensor 421 and then provides a luminance control signal to the adjustable backlight unit 417 for adjusting the backlight luminance. The BI switching device 4273 receives a timing data and then outputs a black insertion switching signal BI Ctrl. The input voltage/output voltage mapping unit 4277 is coupled to the BI switching device 4273 and outputs an voltage mapping data for alternately displaying a dynamic frame with adaptive contrast and a black insertion frame to the arithmetic unit 429 according to the received data of mapping an input gradation to an output gradation after a contrast modulation from the equalization unit 425 and the black insertion switching signal BI Ctrl from the BI switching device 4273. The control signal generator 4275 outputs synchronously the DAC control signal to the DAC unit 415 for enabling or disabling the DAC unit 415.

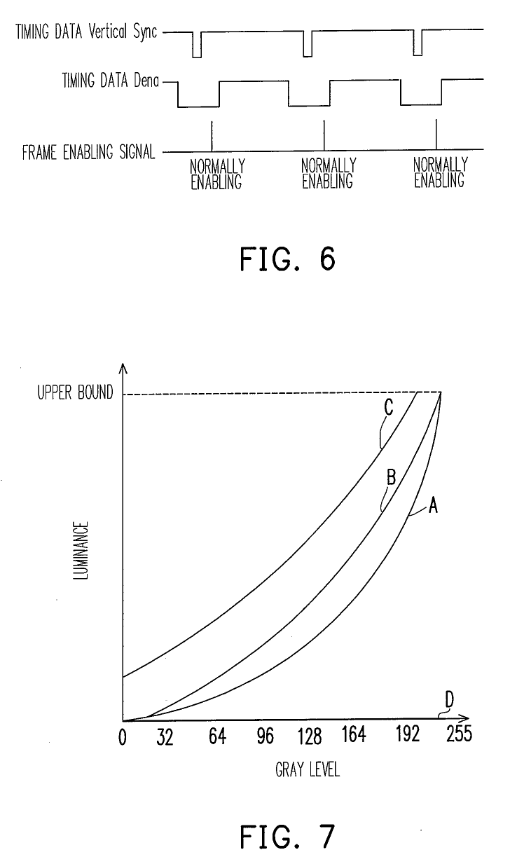

FIG. 6 shows control signal waveforms of an adaptive Gamma voltage switching device 42 according to an embodiment of the present invention. Referring to FIG. 6, when the black insertion switching signal BI Ctrl takes logic-1, the panel 413 displays a black frame; while when the black insertion switching signal BI Ctrl takes logic-0, the panel 413 displays a dynamic frame with adaptive contrast. In other words, the adaptive Gamma voltage switching device 42 is able to generate a frame-enabling signal according to the timing data and the black insertion switching signal BI Ctrl, so that the display frame alternately presents a black insertion frame and a dynamic frame with adaptive contrast to achieve an effect of contrast enhancement and blur drop.

FIG. 7 is a graph showing curves of gradation over output luminance according to an embodiment of the present invention. Referring to FIG. 7, the curve A herein is a basic curve, i.e., a Gamma curve of a frame without contrast enhancement. Corresponding to a dynamic frame with adaptive contrast by using the luminance compensation provided by the light sensor, there are a curve B and a curve C available, wherein the curve B represents the curve of a dynamic frame with adaptive contrast without luminance adjustment where the frame luminance is brighter than the luminance of the curve A, and the curve C represents the curve of a dynamic frame with adaptive contrast with luminance adjustment. Since the optical engine 4271 directly adjusts the adjustable backlight unit 417, the frame luminance of the curve C is brighter than the luminance of the curve B but accompanying a poor luminance saturation occurred at areas near to the edges of the frame. The curve D is a black insertion curve, which represents a Gamma voltage of zero value. When the black insertion switching signal BI Ctrl takes logic-1, the curve D is used to output a luminance of zero value, i.e., a black frame is presented or a frame black insertion is provided. The above-described scheme not only enhances dynamic frame contrast and reduces blur by frame black insertion, but also compensates insufficient luminance caused by frame black insertion.

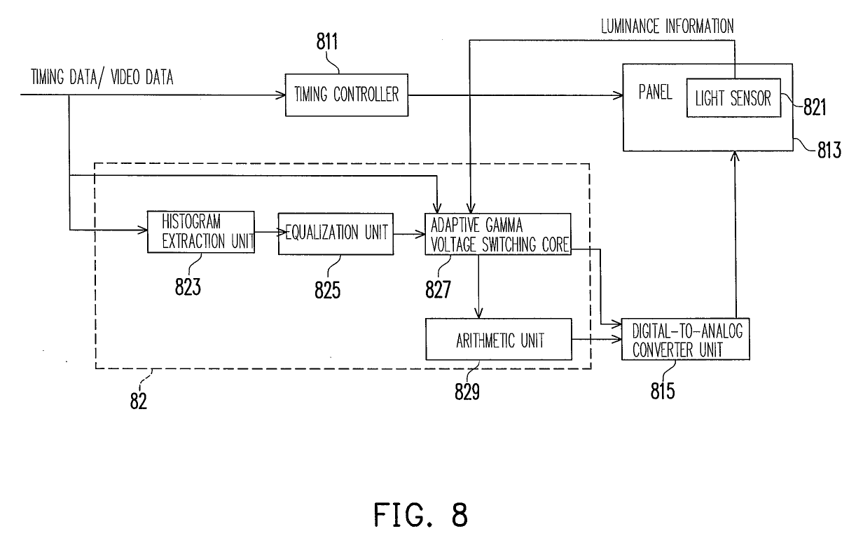

Anyone skilled in the art is able to modify the implementation to meet a specific need according to the spirit of the present invention and the above-described embodiment. Another embodiment is further described in the following. FIG. 8 is a circuit block diagram of an LCD driving circuit with an adaptive Gamma voltage switching device according to another embodiment of the present invention. The LCD driving circuit includes a timing controller 811, a panel 813, a DAC unit 815, an adjustable backlight unit 817, an adaptive Gamma voltage switching device 82 and a light sensor 821. The embodiment is similar to the above-described embodiment except the structure of the AGVS core 827 thereof, which is able to improve insufficient luminance caused by black insertion and solve the luminance saturation problem by adjusting dynamic contrast intensity not by directly controlling the adjustable backlight unit 817 for compensating the insufficient luminance of the panel 813 due to frame black insertion and improving the backlight luminance saturation. The AGVS core 827 of the present embodiment is described in more detail hereinafter.

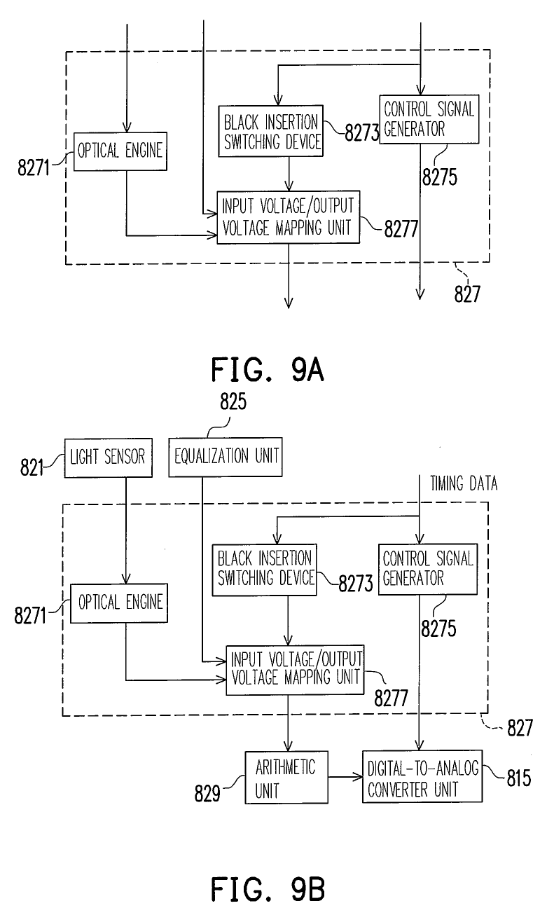

FIG. 9A is a circuit block diagram of an adaptive Gamma voltage switching core 827 according to another embodiment of the present invention and FIG. 9B is a block diagram expressing the relationship between the adaptive Gamma voltage switching core 827 of another embodiment of the present invention and peripheral circuits. Referring to FIGS. 9A and 9B, the AGVS core 827 herein includes an optical engine 8271, a BI switching device 8273, a control signal generator 8275 and a input voltage/output voltage mapping unit 8277. The optical engine 8271 herein receives the luminance data from the light sensor 821 and provides a luminance compensation voltage to the input voltage/output voltage mapping unit 8277. The input voltage/output voltage mapping unit 8277 compensates the luminance of the dynamic frame with adaptive contrast according to the luminance compensation voltage and the black insertion switching signal BI Ctrl of the BI switching device 4873 and outputs an voltage mapping data for alternately displaying a dynamic frame with adaptive contrast and a black insertion frame. In other words, after the optical engine 8271 conducts a processing on the received luminance information, the optical engine 8271 converts the processed luminance information into a data of mapping an input gradation to an output gradation required by the input voltage/output voltage mapping unit 8277 so as to compensate the insufficient luminance caused by frame black insertion and solve the luminance saturation caused by the adjustable backlight unit 817.

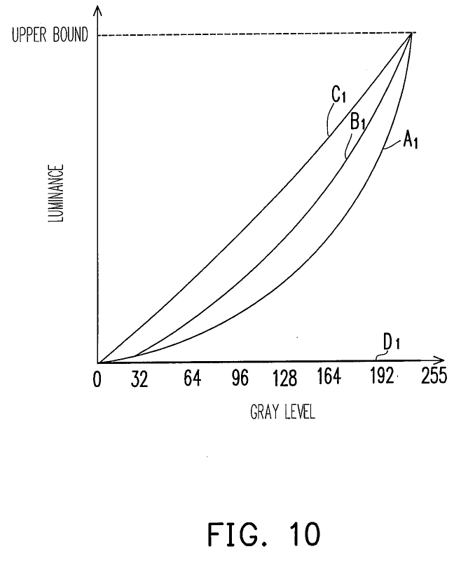

FIG. 10 is a graph showing curves of gradation over output luminance according to various embodiments of the present invention, wherein the curves A1, B1 and D1 are similar to ones of the above-described embodiment, i.e., A1 is a basic dynamic compensation curve, B1 is a dynamic compensation adjustment curve and D1 is a black insertion curve. The curve C1 of the present embodiment represents a case where the luminance information of the light sensor 821 on the panel 813 is received for correcting the mapping relationship between input voltage and output voltage and then the corrected mapping is output to the input voltage/output voltage mapping unit 8277 to directly reduce the distortion at the frame edges and thereby solve the luminance saturation problem.

In summary, the present invention provides an adaptive Gamma voltage switching device which controls the Gamma voltage output and adopts a scheme of switching the Gamma voltage to realize a black insertion, wherein the Gamma voltage is switched by modifying the mapping relationship between input voltage and output voltage. In addition, the luminance data detected by the light sensor is used to correct the mapping relationship between input voltage and output voltage for adjusting the intensity of contrast data, enhancing the brightness perception and improving the dynamic frame quality. The present invention is capable of not only enhancing dynamic contrast and reducing blur by frame black insertion, but also compensating the insufficient luminance caused by the frame black insertion.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An adaptive gamma voltage switching method, comprising:
conducting a statistic processing on a video data to obtain an equalized luminance data of the video data;
dynamically adjusting a Gamma voltage according to the equalized luminance data and providing the adjusted Gamma voltage for converting the video data; and
switching the Gamma voltage for the panel to insert a black insertion frame.

2. The adaptive Gamma voltage switching method according to claim 1, wherein the voltage switching is realized by modifying a mapping relationship between input voltage and output voltage.

3. The adaptive Gamma voltage switching method according to claim 1, further comprising sensing a light displayed by the panel to obtain luminance information and adjusting a backlight module according to the luminance information.

4. The adaptive Gamma voltage switching method according to claim 1, further comprising sensing a light displayed by the panel to obtain luminance information and adjusting the Gamma voltage according to the luminance information.

5. The adaptive Gamma voltage switching method according to claim 1, wherein the step of obtaining the equalized luminance data comprises:
extracting histogram of the video data and obtaining an luminance probability distribution function;
deriving an luminance cumulative distribution function from the luminance probability distribution function; and
calculating the luminance cumulative distribution function to obtain the equalized luminance data.

6. An adaptive gamma voltage switching device, comprising:
an equalization unit, for obtaining an equalized luminance data of the video data by conducting a statistic processing on a luminance cumulative distribution function of a video data; and
an adaptive Gamma voltage switching core, for dynamically adjusting a Gamma voltage according to the equalized luminance data and providing the adjusted Gamma voltage to a digital-to-analog converter unit, wherein the digital-to-analog converter unit converts the video data according to the Gamma voltage so as to enable a panel to alternately display a black insertion frame and a dynamic frame with adaptive contrast.

7. The adaptive gamma voltage switching device according to claim 6, wherein the digital-to-analog converter unit receives a set of Gamma voltages of zero value to enable the panel to display a black insertion frame.

8. The adaptive gamma voltage switching device according to claim 6, further comprising:
a first light sensor, for sensing a light displayed by the panel to obtain luminance information and adjusting a backlight module according to the luminance information.

9. The adaptive gamma voltage switching device according to claim 8, wherein the adaptive Gamma voltage switching core comprises:
an optical engine, for receiving the luminance information and providing an luminance control signal to a backlight module for adjusting a backlight luminance of the backlight module;
a black insertion switching device, for receiving a timing data and outputting a black insertion switching signal;
a control signal generator, for receiving the timing data and outputting a control signal to the digital-to-analog converter unit so as to enable or disable the digital-to-analog converter unit; and
a input voltage/output voltage mapping unit, coupled to the black insertion switching device and the equalization unit, for outputting a voltage mapping data to alternately display a black insertion frame and a dynamic frame with adaptive contrast according to the black insertion switching signal of the black insertion switching device.

10. The adaptive gamma voltage switching device according to claim 6, further comprising:
a second light sensor, for sensing the light displayed by the panel to obtain luminance information and adjusting the Gamma voltage of the adaptive Gamma voltage switching core according to the luminance information.

11. The adaptive gamma voltage switching device according to claim 10, wherein the adaptive Gamma voltage switching core comprises:
an optical engine, for receiving the luminance information and outputting an luminance compensation voltage;
a black insertion switching device, for receiving a timing data and outputting a black insertion switching signal;
a control signal generator, for receiving the timing data and outputting a control signal to the digital-to-analog converter unit so as to enable or disable the digital-to-analog converter unit; and
a input voltage/output voltage mapping unit, coupled to the black insertion switching device, the equalization unit and the optical engine, for receiving the luminance compensation voltage and the black insertion switching signal to compensate the luminance of the dynamic frame with adaptive contrast and outputting a voltage mapping data to alternately display a black insertion frame and a dynamic frame with adaptive contrast.

12. The adaptive gamma voltage switching device according to claim 6, further comprising:
a histogram extraction unit, for conducting a statistic processing on the video data to obtain a luminance probability distribution function and obtaining a luminance cumulative distribution function so that the equalization unit obtains the equalized luminance data by using the luminance cumulative distribution function.
